(19) United States
(12) Patent Application Publication
(10) Pub. No.: US 2007/0162936 A1
(43) Pub. Date: Jul. 12, 2007

(54) INTERACTIVE MAIN MENU GRAPHICAL USER INTERFACE SYSTEMS AND METHODS

(75) Inventors: Heath Stallings, Grapevine, TX (US); Brian Roberts, Frisco, TX (US); Don Relyea, Dallas, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Data Services Inc., Temple Terrace, FL (US)

(21) Appl. No.: 11/614,625

(22) Filed: Dec. 21, 2006

Related U.S. Application Data
(60) Provisional application No. 60/756,572, filed on Jan. 6, 2006.

(51) Int. Cl. H04N 5/445; G06F 3/00; G06F 13/00; H04N 7/173

(52) U.S. Cl. 725/58; 725/42; 725/43; 725/44; 725/38; 725/134

(57) ABSTRACT

In one of many possible examples, a system includes a media content processing subsystem configured to display an interactive main menu graphical user interface having at least a first viewing pane and a second viewing pane, display a stationary magnified area within the first viewing pane, and display a list of entries that is configured to be selectively located within the magnified area within the first viewing pane. Each entry within the list of entries represents content available via the processing subsystem. When one of the entries within the list is located within the magnified area, the processing subsystem is further configured to display content represented by that entry within the second viewing pane.

### RELATED APPLICATIONS

The present application claims priority under 35 U.S.C. § 119(e) to U.S. Provisional Patent Application No. 60/756,572, by Brian Roberts et al., filed on Jan. 6, 2006, and entitled “ADVANCED TELEVISION INTERFACE,” the contents of which are hereby incorporated by reference in their entirety.

### BACKGROUND INFORMATION

The advent of computers, interactive electronic communication, the Internet, and other advances in the digital realm of consumer information utilization have resulted in a great variety of enhanced programming, recording, and viewing options for users who view media content such as television programs. In implementing such enhanced options, the set-top box (“STB”) has become an important computing device for accessing media content services and the media content within those services. In addition to supporting traditional analog broadcast video functionality, STBs also support an increasing number of two-way communication approaches that facilitate services such as video-on-demand, internet protocol television (“IPTV”), and personal video recording.

An STB is typically connected to a cable or satellite, or generally, a subscriber television system, and includes hardware and software necessary to provide enhanced options for a subscriber television system at a subscriber location. Conventional STBs include a processor, communication components, and memory and are connected to a television or other display device, such as a personal computer. While many STBs are stand-alone devices that are externally connected to a television, an STB and/or its functionality may be integrated into a television or personal computer, a mobile device such as a mobile phone or a personal digital assistant (“PDA”), or even into an audio device such as a programmable radio, as is known.

An STB is usually configured to provide users with a large number and variety of media content choices. For example, a user may choose to view a variety of broadcast television programs, pay-per-view services, video-on-demand programming, Internet services, and audio programming via an STB. A user may additionally or alternatively choose to communicate, shop, and/or otherwise interact with third parties via the STB.

However, the large number of options available via a STB often makes it difficult for an STB user to effectively manage and easily access those options. For example, it is often cumbersome to find and select a desired media content instance for viewing and/or access any of the other features of the STB. On-screen graphical user interfaces have alleviated this confusion to some degree. However, many on-screen user interfaces are difficult to use and therefore result in missed viewing opportunities.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical reference numbers designate identical or similar elements.

FIG. 1 illustrates an example of a media content access system according to principles described herein.

FIG. 2 is an illustration of an exemplary media content provider network according to principles described herein.

FIG. 3 is a block diagram of an exemplary media content processing subsystem according to principles described herein.

FIG. 4 illustrates an exemplary user input device according to principles described herein.

FIG. 5 illustrates a viewing screen of an exemplary display device with a particular scene or frame of media content displayed thereon according to principles described herein.

FIG. 6 illustrates an exemplary main menu graphical user interface (“GUI”) according to principles described herein.

FIG. 7 shows another view of the exemplary main menu GUI according to principles described herein.

FIG. 8 shows the main menu GUI after a particular entry within a search results list has been selected according to principles described herein.

FIG. 9 shows another exemplary view of the main menu GUI according to principles described herein.

FIG. 10 shows an exemplary view of the main menu GUI with an expandable history tab according to principles described herein.

FIG. 11 shows the main menu GUI after the expandable history tab of FIG. 10 has been expanded according to principles described herein.

FIG. 12 shows the main menu GUI after a user has selected an option to search for one or more media content instances according to principles described herein.

FIG. 13 shows another exemplary view of the main menu GUI according to principles described herein.

FIG. 14 shows another exemplary view of the main menu GUI according to principles described herein.

FIG. 15 shows another exemplary view of the main menu GUI according to principles described herein.

FIG. 16 shows another exemplary view of the main menu GUI according to principles described herein.

FIG. 17 shows another exemplary view of the main menu GUI according to principles described herein.

FIG. 18 illustrates an exemplary method of providing a capability of searching and/or browsing through content that may be available via the processing subsystem according to principles described herein.

### DETAILED DESCRIPTION OF PREFERRED EMBODIMENTS

### I. Introduction

Exemplary systems and methods for providing a capability of searching and/or browsing through content that may be available via a media content processing subsystem are described herein. As used herein, the term “content” will be used to refer generally to any option, feature, media content instance, and/or directory thereof that is accessible via a media content processing subsystem.

The exemplary systems and methods described herein generally enable a user to easily, effectively, and intuitively search for and/or browse through content available via a media content processing subsystem. In some examples, a user may access and navigate through any content available via the media content processing subsystem simply by using the navigational buttons located on any user input device (e.g., a remote control).

In some examples, a media content processing subsystem, such as a set-top box (“STB”), is configured to display an interactive main menu user interface (“GUI”) having at least a first viewing pane and a second viewing pane. The first and second viewing panes may additionally or alternatively be referred to as “primary” and “secondary” viewing panes, respectively. A stationary magnified area may also be displayed within the first viewing pane. The stationary magnified area is configured to highlight or otherwise distinguish information contained therein. A list of entries, each representing content available via the processing subsystem, is displayed within the first viewing pane and configured to be selectively located within the magnified area. Content represented by a particular entry located within the magnified area is displayed within the second viewing pane. When a new entry is moved into the magnified area, the second viewing pane is automatically updated to display content associated therewith.

Components and functions of the exemplary systems and methods described herein will now be described in more detail.

### II. Exemplary System View

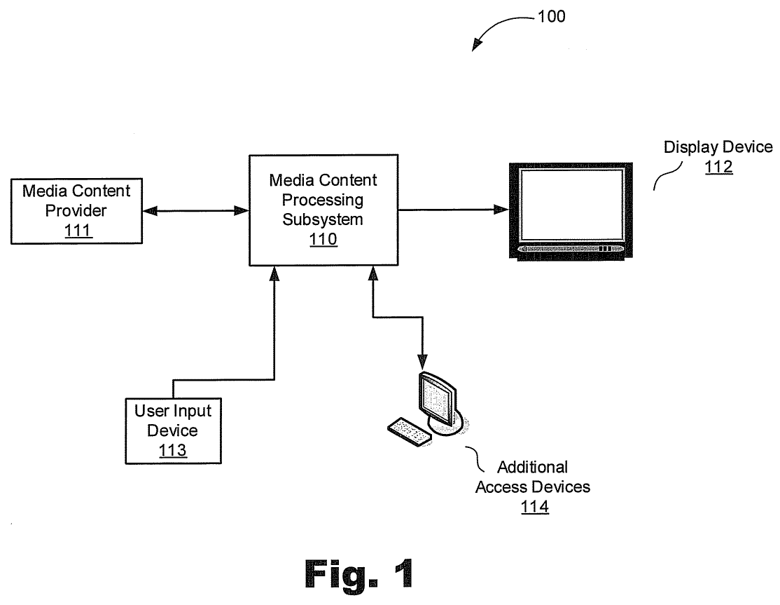

FIG. 1 illustrates an exemplary media content access system 100. Media content access system 100 may take many different forms and include multiple and/or alternate components and facilities.

As shown in FIG. 1, a media content processing subsystem 110 is configured to communicate with and receive a signal or data stream (e.g., a media content stream) containing a media content instance from a media content provider 111. As used herein, the term “media content instance” will be used to refer generally to any television program, on demand program, pay-per-view program, broadcast media program, IPTV, commercial, advertisement, video, movie, song, image, photograph, sound, or any segment of these or other forms of media content that may be experienced or viewed by a user.

The media content processing subsystem 110 and media content provider 111 may communicate using any known communication technologies, devices, media, and protocols supportive of remote data communications, including, but not limited to, cable networks, subscriber television networks, satellite networks, the Internet, intranets, local area networks, wireless networks (e.g., mobile telephone networks), optical fiber networks, data transmission media, communications devices, Transmission Control Protocol (“TCP”), Internet Protocol (“IP”), File Transfer Protocol (“FTP”), telnet, Hypertext Transfer Protocol (“HTTP”), socket connections, Ethernet, and other suitable communications networks and technologies.

The media content processing subsystem 110 may use any suitable technology or technologies to receive the media content instance from the media content provider 111, including using a tuner to receive the media content instance, as described below. The media content processing subsystem 110 may be configured to process the media content stream provided by the media content provider 111, including causing the media content instance, or one or more components (e.g., video and/or audio components) of the media content instance, to be presented for experiencing (e.g., viewing) by a user. The presentation of the media content instance may include, but is not limited to, displaying, playing back, or otherwise processing the media content instance, or one or more components of the media content instance, such that it may be experienced by the user. For example, the media content processing subsystem 110 may provide a signal to a display device 112 (e.g., a television, computer monitor, etc.) so that the display device 112 may present (e.g., display) the media content instance for experiencing by the user.

As shown in FIG. 1, and as will be described in more detail below, the media content processing subsystem 110 may be controlled by a user input device 113 (e.g., a remote control device) and/or a number of additional access devices 114 (e.g., a personal computer, wireless device, mobile phone, etc.).

While an exemplary media content access system 100 is shown in FIG. 1, the exemplary components illustrated in FIG. 1 are not intended to be limiting. Indeed, additional or alternative components and/or implementations may be used, as is well known. Each of the components of system 100 will now be described in additional detail.

A. Media Content Provider

Media content provider 111 is configured to provide various types of media content via a satellite, cable system, subscriber television network, the Internet, optical fiber network, wireless network, or any other suitable network. The media content may include, but is not limited to audio-visual content (e.g., broadcast television programs, pay-per-view services, Internet Protocol Television (“IPTV”), Digital Video Disc (“DVD”) related content, or video-on-demand programming), pre-recorded media content, data communication services such as Internet services, images, and audio programming.

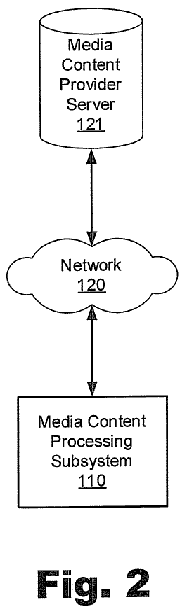

An exemplary media content provider 111 includes a media content provider server 121, as shown in FIG. 2. The media content provider server 121 may be configured to communicate with the media content processing subsystem 110 via one or more types of networks 120 (and communications links thereto). The network 120 shown in FIG. 2 may include the Internet, an intranet or other private packet-switched network, a cable television network (e.g., hybrid fiber-coax network), a wireless broadcast network (e.g., a satellite media broadcasting network or terrestrial broadcasting network), a telephone network, a provider-specific network (e.g., a Verizon® FIOS® network and/or a TiVo® network), an optical fiber network, or any other suitable network. In some alternative examples, the processing subsystem 110 may be connected directly to the media content provider server 121.

B. Display Device

As mentioned, the processing subsystem 110 may be coupled to a display device 112 configured to present media content to a user. For example, the display device 112 may display or play the media content. The display device 112 may include, but is not limited to, a television, computer monitor, mobile phone, handheld device, or any other device configured to present media content to a user.

C. Media Content Processing Subsystem

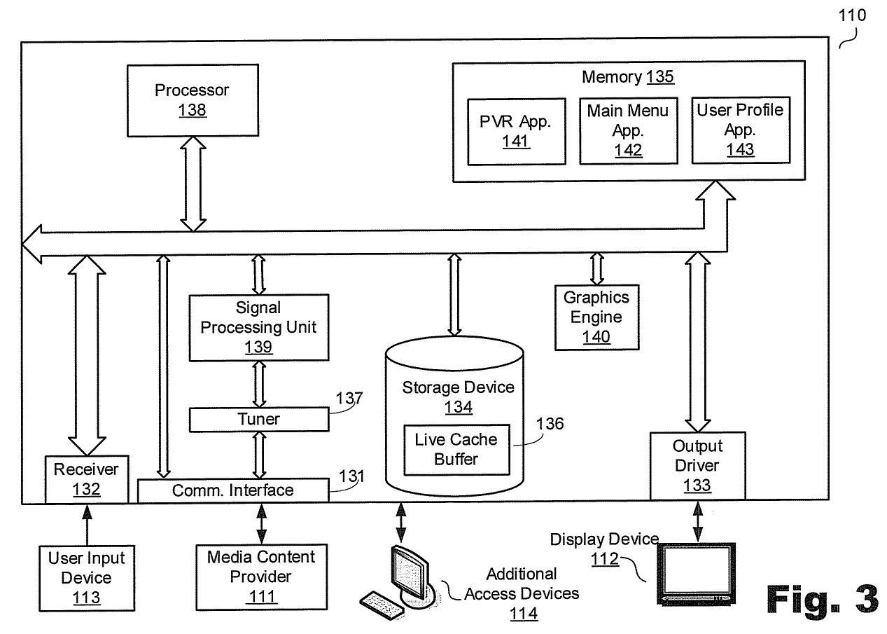

FIG. 3 is a block diagram of an exemplary media content processing subsystem 110 (or simply “processing subsystem 110”). The processing subsystem 110 may include any combination of hardware, software, and firmware configured to process an incoming media content stream. As used herein and in the appended claims, unless otherwise specifically denoted, the terms “media content processing subsystem” and “processing subsystem” will be used to refer expansively to all possible devices that receive and process digital and/or analog media content. Hence, an exemplary processing subsystem 110 may include, but is not limited to, a set-top box (“STB”), a home communication terminal (“HCT”), a digital home communication terminal (“DHCT”), a stand-alone personal video recorder (“PVR”), a television set, a DVD player, a video-enabled phone, and/or a personal computer.

In some examples, the processing subsystem 110 may include any computer hardware and/or instructions (e.g., software programs), or combinations of software and hardware, configured to perform the processes described herein. In particular, it should be understood that processing subsystem 110 may be implemented on one physical computing device or may be implemented on more than one physical computing device. Accordingly, processing subsystem 110 may include any one of a number of well known computing devices, and may employ any of a number of well known computer operating systems, including, but by no means limited to, known versions and/or varieties of the Microsoft Windows® operating system, the UNIX operating system, Macintosh® operating system, and the Linux® operating system.

Accordingly, the processes described herein may be implemented at least in part as instructions executable by one or more computing devices. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

While an exemplary processing subsystem 110 is shown in FIG. 3, the exemplary components illustrated in FIG. 3 are not intended to be limiting. Indeed, additional or alternative components and/or implementations may be used. Various components of the processing subsystem 110 will now be described in additional detail.

1. Communication Interfaces

As shown in FIG. 3, the processing subsystem 110 may include a communication interface 131 configured to receive media content in any format from the media content provider 111 or from any other suitable media content source. The communication interface 131 may include any device, logic, and/or other technologies suitable for receiving signals and/or data representative of media content. In some examples, the communication interface 131 may include a single port configured to receive media content from the media content provider 111 and/or from any other source (e.g., from another processing subsystem, another server, etc.) For example, the communication interface 131 may include or be connected to a broadband connection, which can enable the processing subsystem 110 to receive media content on a single port from multiple sources. In other examples, multiple ports may be used. The communication interface 131 may be configured to interface with any suitable communication media, protocols, and formats, including any of those mentioned above.

The processing subsystem 110 may also include a receiver 132 configured to receive one or more input commands from one or more user input devices 113. An exemplary user input device 113 will be described in more detail below.

A number of additional access devices 114 may also be configured to communicate with the processing subsystem 110. These access devices 114 may include, but are not limited to, personal computers and mobile devices (e.g., laptops, PDAs, cellular phones, etc.). In some examples, the access devices 114 may be configured to access content stored and/or processed by the processing subsystem 110. For example, media content that has been recorded by the processing subsystem 110 may be accessed and viewed on a personal computer. Moreover, the additional access devices 114 may be used to program or otherwise control the functions of the processing subsystem 110.

The processing subsystem 110 may also include an output driver 133 configured to interface with or drive the display device 112. The output driver 133 may include any combination of hardware, software, and firmware as may serve a particular application.

2. Storage Devices

Storage device 134 may include one or more data storage media, devices, or configurations and may employ any type, form, and combination of storage media. For example, the storage device 134 may include, but is not limited to, a hard drive, network drive, flash drive, magnetic disc, optical disc, or other non-volatile storage unit. Various portions of media content may be temporarily and/or permanently stored in the storage device 134.

The storage device 134 of FIG. 3 is shown to be a part of the processing subsystem 110 for illustrative purposes only. It will be understood that the storage device 134 may additionally or alternatively be located external to the processing subsystem 110.

The processing subsystem may also include memory 135. Memory 135 may include, but is not limited to, FLASH memory, random access memory (RAM), dynamic RAM (DRAM), or a combination thereof. In some examples, as will be described in more detail below, various applications used by the processing subsystem 110 may reside in memory 135.

As shown in FIG. 3, the storage device 134 may include one or more live cache buffers 136. The live cache buffer 136 may additionally or alternatively reside in memory 135 or in a storage device external to the processing subsystem 110. In some examples, media content data may be temporarily stored in the live cache buffer 136 to facilitate viewing of the media content in one or more trick play modes.

3. Tuner

Tuner 137 is configured to tune to a particular television channel, stream, address, frequency or other carrier (i.e., content carrier) in order to process media content that is transmitted on that carrier. In some examples, the tuner 137 may include multiple tuners such that multiple carriers of media content may be processed and/or shown on a display device 112. For example, the tuner 137 may include a first tuner configured to receive an analog video signal corresponding to a first media content instance and a second tuner configured to simultaneously receive a digital compressed stream corresponding to a second media content instance. It will be recognized that the tuner 137 may have any number of tuners configured to receive any kind of media content.

In some examples, media content received at the tuner 137 is temporarily buffered, or stored, in the live cache buffer 136. If there are multiple tuners 137, there may be a live cache buffer 136 corresponding to each of the tuners 137. Once media content is temporarily stored in the live cache buffer 136, the user may then designate whether the media content is to be permanently stored as a permanent recording in the storage device 134 or whether the media content is to be deleted. As used herein, the term “permanent recording” will be understood to mean media content that is stored for an extended period of time as decided by the user.

4. Processors

As shown in FIG. 3, the processing subsystem 110 may include one or more processors, such as processor 138 configured to control the operations of the processing subsystem 110. The processing subsystem 110 may also include a signal processing unit 139 configured to process incoming media content. The signal processing unit 139 may be configured, for example, to demodulate and parse encoded digital media content. In some examples, the processing subsystem 110 may include one or more signal processing units 139 corresponding to each of the tuners 137.

In some examples, if the incoming media content is in the form of IP data packets (e.g., in IPTV configurations), the media content may be processed directly by the processor 138 and/or any other processor configured to process IP data packets.

The processing subsystem 110 may also include a graphics engine 140 configured to generate graphics that are to be displayed by the display device 112. The graphics may include graphical user interfaces (“GUIs”) such as, but not limited to, one or more program guides, progress bars, and other graphics.

5. Application Clients

Returning to FIG. 3, one or more applications 141-143 residing within the processing subsystem 110 may be executed upon initiation by a user of the processing subsystem 110. The applications 141-143, or application clients, may reside in memory 135 or in any other area of the processing subsystem 110 and be executed by the processor 138. The applications 141-143 shown in FIG. 3 are merely illustrative of the many different applications that may reside within the processing subsystem 110.

As shown in FIG. 3, one of the applications may include a personal video recording (“PVR”) application 141. A PVR application is also referred to as a digital video recording (“DVR”) application. As used herein, the term “PVR application” will be used to refer to any application or device configured to record media content and/or provide for the viewing of media content in trick play mode. As previously mentioned, trick play modes include, but are not limited to, slow motion, fast motion, reverse play, fast forward play, instant replay, jumping, pausing of live broadcast, and scanning. The PVR application 141 may also provide for media content recording functionality by enabling the temporary and/or permanent recording of media content to the storage device 134.

The processing subsystem 110 may additionally or alternatively include a main menu application 142 configured to generate a main menu that is displayed on the display device 112. An exemplary main menu includes a GUI that performs various functions including allowing a user to access one or more options, features, and/or media content instances via the processing subsystem 110.

In some examples, the processing subsystem 110 also includes a user profile application 143 configured to enable a user to program one or more user profiles within the processing subsystem 110. A user profile may include one or more customized or personalized settings that affect any aspect of media content that may be accessed via the processing subsystem 110. For example, as will be described in more detail below, a user profile may include a “whitelist” specifying one or more accessible media content instances, a “blacklist” specifying one or more media content access restrictions, customized display settings, and/or any other customized setting.

D. User Input Device

User input device 113 (or simply “input device 113”) may include, for example, a remote control, keyboard, or any other suitable input device and may be configured to communicate with the receiver 132 via a wireless link, electrical connection, or any other suitable communication link.

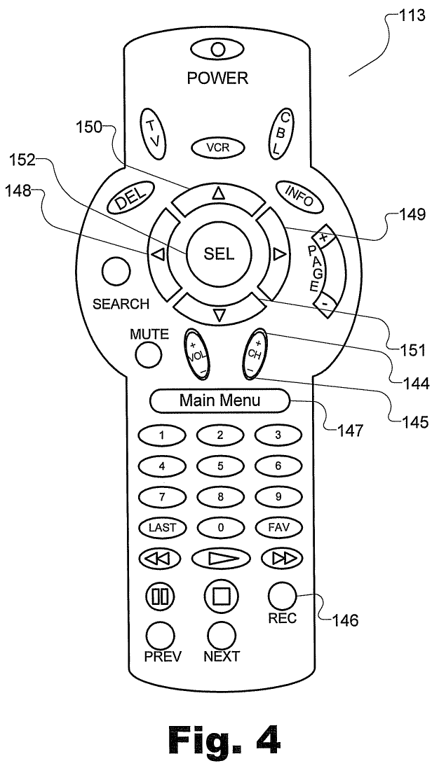

An exemplary remote control input device 113 is illustrated in FIG. 4. It will be recognized that the input device 113 shown in FIG. 4 is merely illustrative of the many different types of input devices that may be used in connection with the present systems and methods.

In some examples, the input device 113 may include any number of buttons or keys configured to enable a user to control various options related to media content available via the processing subsystem 110. For example, channel up and down buttons 144 and 145 enable a user to navigate to and between various media content instances. A record button 146 may also be included which enables the user to designate as permanently recorded any media content instance buffered in the live cache buffer 136. A main menu button 147 may be configured to evoke the display of a main menu GUI by the display device 112. Navigational buttons, such as a left arrow button 148, right arrow button 149, up arrow button 150, down arrow button 151, and select button 152 may also be included and configured to enable the user to evoke and/or navigate through various views and graphical user interfaces displayed by the display device 112.

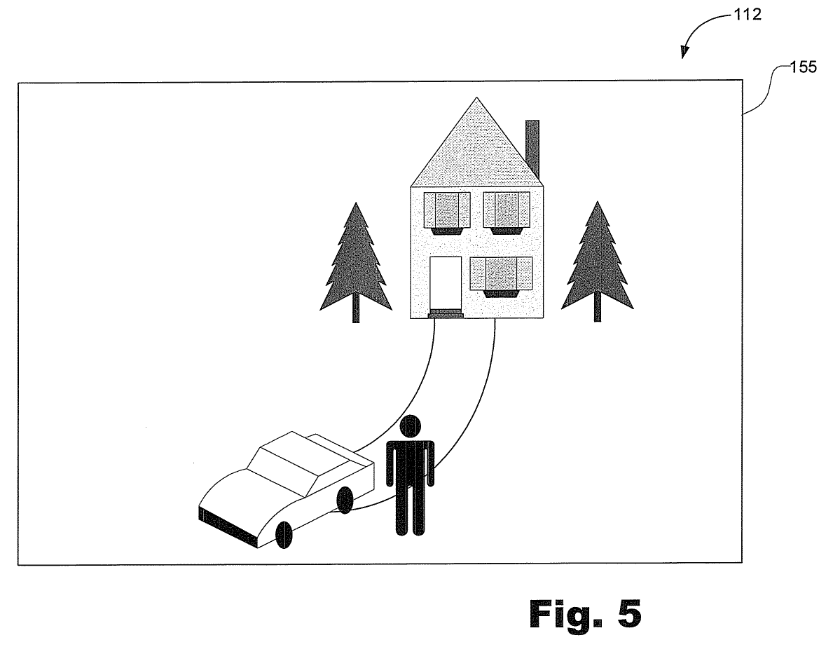

FIG. 5 illustrates a viewing area or screen 155 of an exemplary display device 112 with a particular scene or frame of a media content instance displayed thereon. In some examples, the user may be interested in experiencing a different media content instance and/or viewing information related to one or more other media content instances. The user may additionally or alternatively be interested in accessing various settings, communication mediums, purchasing venues, and/or any other option or feature of the media content processing subsystem 110.

However, there may be a relatively large number (e.g., thousands) of media content instances and/or options available via the processing subsystem 110. To this end, a main menu GUI may be displayed by the display device 112 that is configured to allow a user to easily and intuitively access and browse through any content available via a media content processing subsystem 110. Such content includes, but is not limited to, one or more options, features, and/or media content instances available via the media content processing subsystem 110. As will be described in more detail below, the main menu GUI may be configured to allow a user to access the content contained therein by using only the four directional arrow buttons 148-151 and the select button 152 that are a part of the user input device 113. However, it will be recognized that any other button that is a part of the input device 113 may additionally or alternatively be used to access content contained within the main menu GUI.

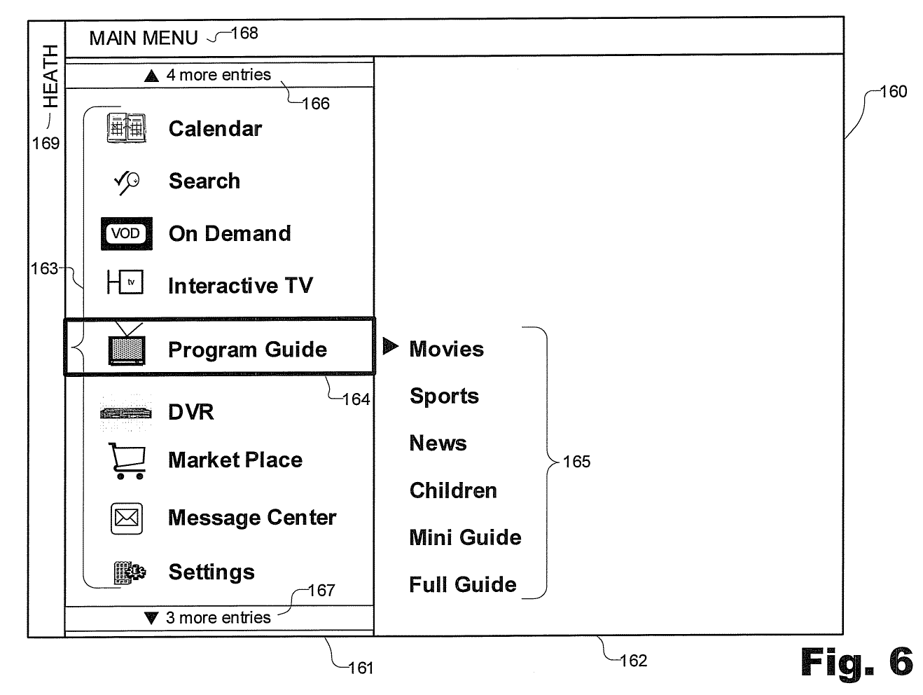

FIG. 6 illustrates an exemplary main menu GUI 160 that may be displayed by the display device 112. The main menu GUI 160 may be evoked using a number of different methods. For example, the user may select a dedicated button on a user input device (e.g., the main menu button 147 on the user input device 113 or one of the arrow buttons 148-151). Additionally or alternatively, the main menu GUI 160 may be evoked by selecting an option within any other GUI as may serve a particular application.

In some examples, the main menu GUI 160 of FIG. 6 may occupy substantially the entire viewing screen 155 of the display device 112. However, it will be recognized that the main menu GUI 160 may alternatively occupy only a portion of the viewing screen 155 such that a media content instance may be simultaneously displayed thereon.

As shown in FIG. 6, the main menu GUI 160 may include two interactive viewing panes, labeled 161 and 162 respectively. It will be recognized that the main menu GUI 160 may alternatively include any other number of viewing panes as may serve a particular application. In some examples, as will be described in more detail below, the contents of the second viewing pane 162 may be dynamically updated to display various entries related to a select entry within the first viewing pane 161.

As shown in FIG. 6, the first viewing pane 161 may include a main menu listing 163 of selectable entries within a main menu directory, sub-directory, or folder. As used herein, the terms “directory”, “sub-directory”, and “folded” generally refer to a grouping of one or more related options, features, media content instances, and/or other content utilizing some form of a hierarchical representation.

Each entry within the main menu listing 163 corresponds to a directory of one or more options that may be accessed via the processing subsystem 110. For example, the main menu listing 163 may include entries configured to allow access to one or more of the following options or features: calendar options, search options, on demand programming options, interactive television options, program guide listings, DVR options, shopping options, messaging and communication options, settings, and help options. It will be recognized that the main menu listing 163 may include additional or alternative entries as may serve a particular application. For example, one or more customized entries may be included within the main menu listing 163 such as, but not limited to, a directory containing personalized media content (e.g., photos, music, videos, games, and contacts).

In some examples, one or more graphics corresponding to one or more of the entries within the main menu listing 163 may also be displayed within the first viewing pane 161. These graphics may be changed or removed by a user as desired.

In some examples, a user may browse through the main menu listing 163 with the up and down arrow buttons 150 and 151, for example, and select a desired entry by pressing a designated button (e.g., the right arrow button 149 or the select button 152) when the desired entry is located within a “magnified area.” As used herein, the term “magnified area” 164 will be used to refer to a fixed focus state or area within a viewing pane (e.g., the first viewing pane 161) that is in some way distinguished from the rest of the viewing pane 161. For example, as shown in FIG. 6, the magnified area 164 is surrounded by a distinguishing border. The magnified area 164 may additionally or alternatively include a distinct color, brightness, text size, and/or any other distinguishing feature. In some alternative examples, an audible description of the entry within the magnified area 164 may be provided. Exemplary magnified areas are described in further detail in co-pending U.S. patent application Ser. No. 11/500,208, entitled “PROGRAM GUIDE GRAPHICAL USER INTERFACE SYSTEMS AND METHODS,” filed Aug. 7, 2006 and incorporated herein by reference in its entirety.

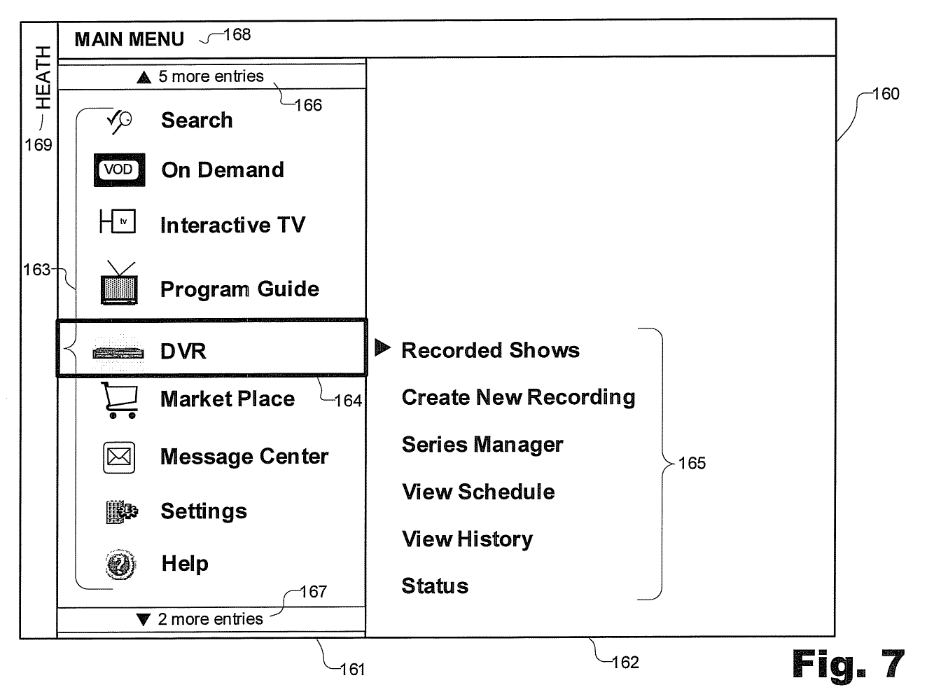

The magnified area 164 may be configured to remain stationary in relation to the scrolling main menu listing 163. Hence, as a user scrolls up or down through the main menu listing 163 of selectable entries, the entry directly above or below the magnified area 164 moves into the magnified area 164. For example, FIG. 7 shows the main menu GUI 160 after a user has pressed the down arrow button 151 once. As shown in FIG. 7, the main menu listing 163 has been scrolled up and the “DVR” entry is now within the magnified area 164.

The magnified area 164 may be centered vertically within the first viewing pane 161, as shown in FIGS. 6-7. It will be recognized that the magnified area 164 may alternatively be positioned at any other location within the first viewing pane 161.

As shown in FIGS. 6-7, a filtered view of content related to the entry that is within the magnified area 164 may be displayed within the second viewing pane 162. For example, a content list 165 containing one or more selectable entries that are related to the entry that is within the magnified area 164 may be displayed within the second viewing pane 162. To illustrate, FIG. 6 shows a content list 165 related to the “Program Guide” entry that is within the magnified area 164. FIG. 7 shows that the content list 165 may be updated to include a number of entries related to the “DVR” entry when the “DVR” entry enters the magnified area 164.

In this manner, the second viewing pane 162 is configured to display a “preview” of content related to a particular entry located within the magnified area 164 before the entry is selected by the user. It will be recognized that the filtered view displayed within the second viewing pane 162 may alternatively include other types of content.

In some examples, as shown in FIGS. 6-7, the main menu GUI 160 may include a header field 166 and/or a footer field 167 configured to indicate the number of entries within the main menu listing 163 that are not currently being displayed within the viewing screen 155. In this manner, the user may easily see that he or she may scroll up and/or down to access additional entries within the main menu listing 163. The header and footer fields 166 and 167 are also referred to as “slugs.”

For example, the header field 166 shown in FIG. 6 indicates that four additional entries above the “Calendar” entry are currently out of view. Likewise, the footer field 167 shown in FIG. 6 indicates that three additional entries below the “Settings” entry are currently out of view. If the user scrolls the main menu listing 163 up one entry, as shown in FIG. 7, the header and footer fields 166 and 167 are automatically updated to reflect the new number of entries that are out of view.

In some examples, as shown in FIGS. 6-7, the header and footer fields 166 and 167 are displayed within the first viewing pane 161. However, it will be recognized that the header and footer fields 166 and 167 may additionally or alternatively be displayed at any other location within the main menu GUI 160 as may serve a particular application.

Moreover, it will be recognized that an additional header field and/or footer field may be used in connection with any other content list that is displayed within either the first or second viewing panes 161 or 162 as may serve a particular application. For example, a header and/or footer field may be used to indicate the number of entries within the content list 165 that are not currently being displayed within the second viewing pane 162.

In some examples, the main menu GUI 160 may additionally or alternatively include a field 168 wherein the name of the directory that is currently being displayed within the first viewing pane 161 is indicated. For example, field 168 shown in FIGS. 6-7 indicates that the name of the directory currently being displayed within the first viewing pane 161 is entitled “MAIN MENU.” The field 168 is updated automatically when a new directory is displayed within the first viewing pane 161.

Field 168 may be displayed in any suitable location within the main menu GUI 160. For example, as shown in FIGS. 6-7, field 168 may be displayed as a header that extends across the entire GUI 160.

The main menu GUI 160 may additionally or alternatively be configured to display another field 169 wherein the name of a currently active user profile is indicated. For example, field 169 shown in FIGS. 6-7 indicates that the name of the user profile currently being used is “HEATH.” If a particular user profile is selected to be active, the processing subsystem 110 may be configured to execute commands received from the input device 113 in accordance with one or more rules specified within that particular user profile.

In some examples, a user profile may store information such as, but not limited to, a name of a user, identification information (e.g., customer account numbers, demographic information, and gender), avatar graphics, and other customizable information related to interactions between the user and the processing subsystem 110.

A user profile may additionally or alternatively include one or more rules regarding the display of the main menu GUI 160. For example, a select number of entries may be displayed within the main menu GUI 160 in a particular user profile. In other examples, a particular user profile may specify a color scheme for the main menu GUI 160. It will be recognized that a user profile may specify any other aspect of the main menu GUI 160.

In some alternative examples, access to one or more of the entries within the main menu listing 163 may be permitted and/or restricted within a particular user profile. For example, a user profile may include a “whitelist” specifying one or more accessible entries within the main menu GUI 160 and/or a “blacklist” specifying one or more restricted or blocked entries within the main menu GUI 160.

In some examples, user profile information may be stored locally at the processing subsystem 110. Additionally or alternatively, user profile information may be stored within a network, the input device 113, and/or any other storage medium.

As shown in FIGS. 6-7, the field 169 containing the name of the currently active user profile may be vertically oriented in a top-left corner of the main menu GUI 160. However, it will be recognized that field 169 may additionally or alternatively be displayed at any other location within the main menu GUI 160.

As mentioned, a user may select a desired entry within the main menu listing 163 by pressing the right arrow button 149 or the select button 152 when the desired entry is located within the magnified area 164. It will be recognized that a desired entry may be selected in any other manner as may serve a particular application. When an entry within the main menu listing 163 is selected, the content list 165 related to the selected entry is transferred from the second viewing pane 162 to the first viewing pane 161 and a new filtered view is displayed within the second viewing pane 162. As will be described in more detail below, the new filtered view may include a content list that is related to one of the entries within the content list 165.

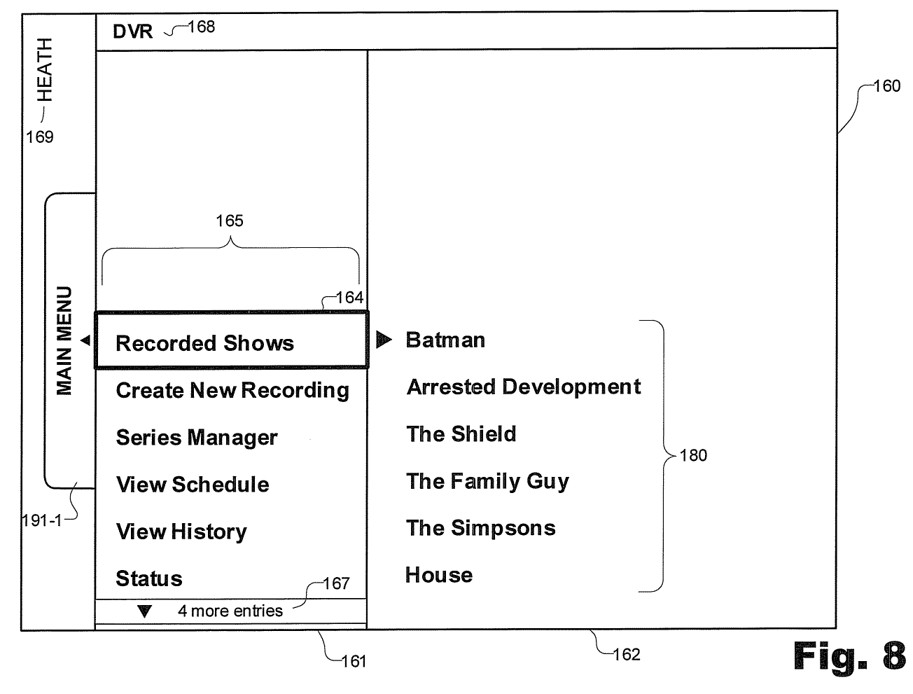

For example, FIG. 8 shows the main menu GUI 160 after the “DVR” entry has been selected. As shown in FIG. 8, content list 165 has been transferred to the first viewing pane 161. A user may then use the up and down arrow buttons 151 and 152 to browse through the content list 165.

When a particular entry enters the magnified area 164, a filtered view of that entry appears in the second viewing pane 162 in a manner similar to that already described in connection with the main menu listing 163. For example, FIG. 8 shows that an entry labeled “Recorded Shows” is currently within the magnified area 164. Hence, a content list 180 containing a number of entries related to the “Recorded Shows” entry is displayed within the second viewing pane 162. The content list 180 may include, as shown in FIG. 8, a number of television shows that have been recorded by the user.

It will be recognized that field 168 has been updated in FIG. 8 to indicate that the “DVR” directory is currently displayed within the first viewing pane 161. Moreover, it will also be recognized that footer field 167 has been updated to indicate that there are four entries not currently displayed within the first viewing pane 161.

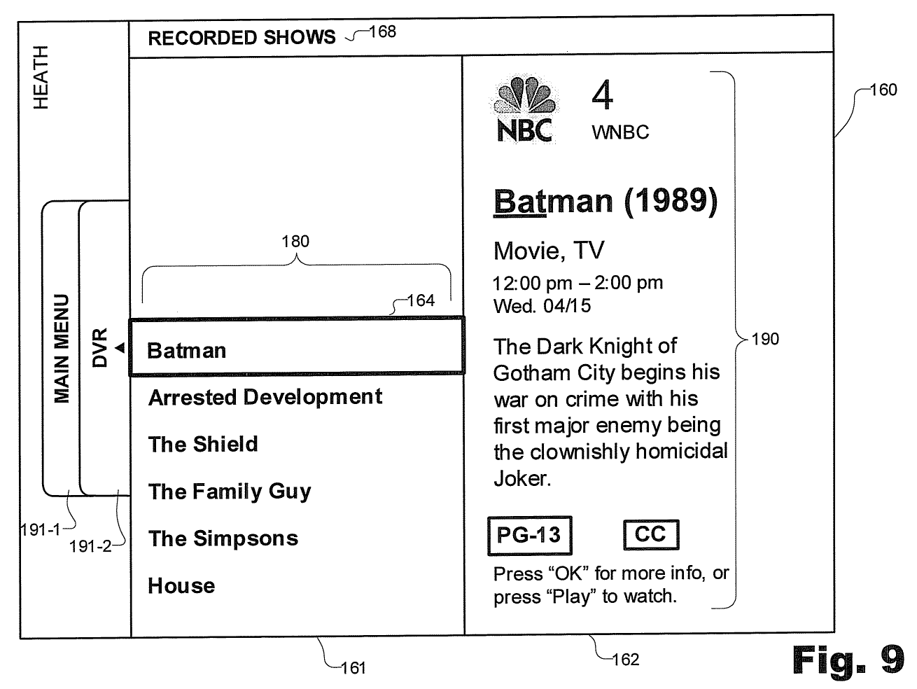

To select one of the entries within the content list 165, the user simply presses the right arrow button 149 or the select button 152 when the desired entry is located within the magnified area 164. For example, FIG. 9 shows the main menu GUI 160 after the “Recorded Shows” entry has been selected. As shown in FIG. 9, content list 180 has been transferred to the first viewing pane 161. The second viewing pane 162 may then display program information corresponding to an entry that is located within the magnified area 164. For example, the second viewing pane 162 illustrated in FIG. 9 shows program information 190 corresponding to “Batman,” which entry is currently within the magnified area 164.

In some examples, as shown in FIGS. 8-9, one or more history tabs (e.g., 191-1 and 191-2, collectively referred to herein as 191) may be included within the main menu GUI 160. The history tabs 191 may be vertically oriented along the left-hand side of the first viewing pane 161, as shown in FIGS. 8-9. Additionally or alternatively, the history tabs 191 may be located and/or oriented in any other suitable manner.

The history tabs 191 are configured to graphically display the names of one or more directories within a browsing path or thread created by a user during a particular browsing session. Each tab 191 may be selectable and may be labeled so that the user can easily go back to a particular directory within the browsing thread and select a different entry contained therein without having to restart the browsing thread.

To illustrate, FIG. 9 illustrates two exemplary history tabs 191-1 and 191-2. As indicated by the titles contained therein, history tab 191-1 corresponds to the “Main Menu” directory and history tab 191-2 corresponds to the “DVR” sub-directory within the “Main Menu” directory. Hence, to return to the “DVR” directory, a user may press the left arrow button 148 once. Upon so doing, the main menu GUI 160 may be updated to display the view shown in FIG. 8. Alternatively, the user may press the left arrow button 148 twice to return to the “Main Menu” directory. The main menu GUI 160 may accordingly be updated to display the view shown in FIG. 7.

It will be recognized that as a user goes deeper into a browsing thread, the screen space required to display the corresponding history tabs 191 increases. Hence, after a certain number of tabs 191 are displayed, it becomes infeasible to display more tabs 191 without encroaching on the screen space needed for the first and second viewing panes 161 and 162. In such a situation, in one approach, the nature of the tabs 191 may be changed (e.g., placed in a linear staggered manner using available vertical space adjacent the current placement of tabs 191-1 and 191-2).

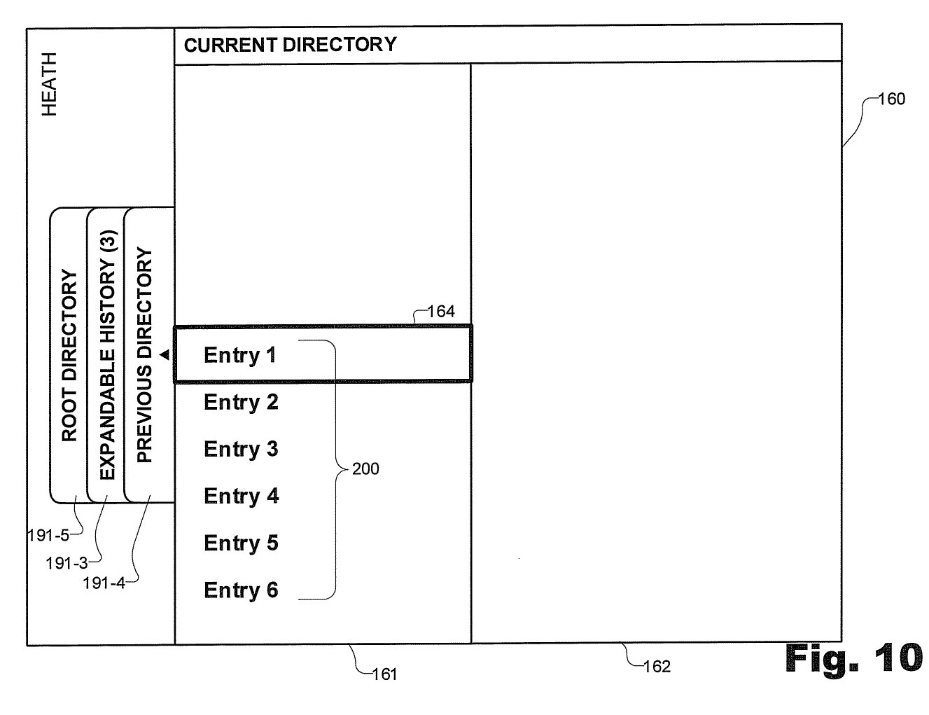

Alternatively, as shown in FIG. 10, an expandable history tab 191-3 may be displayed after a pre-determined number of history tabs 191 are displayed. FIG. 10 illustrates an exemplary generic layout of the main menu GUI 160 wherein a number of history tabs 191, including an expandable history tab 191-3, are displayed. As shown in FIG. 10, a content list 200 located within a particular directory labeled “current Directory” is displayed within the first viewing pane 161. In some examples, the content list 200 is located deep within a multiplicity of directories. Hence, the expandable history tab 191-3 graphically represents a plurality of hidden history tabs that are not displayed because of space limitations. The hidden history tabs represent a plurality of directories within the path of the “Current Directory.”

In some examples, a history tab 191-4 corresponding to a directory that is previous to the currently displayed directory and a history tab 191-5 corresponding to a root directory may additionally be displayed. The root directory may include the main menu directory shown in FIGS. 6-7, for example.

In this manner, a user may easily backtrack to a particular directory within the browsing thread. To access one or more of the hidden history tabs, a user may select the expandable search history tab 191-3 by, for example, pressing the left arrow button 148 twice. When selected, the expandable search history tab 191-3 is configured to expand and show a number of the hidden search history tabs. The user may then select one of the hidden search history tabs to return to a directory corresponding to the selected tab.

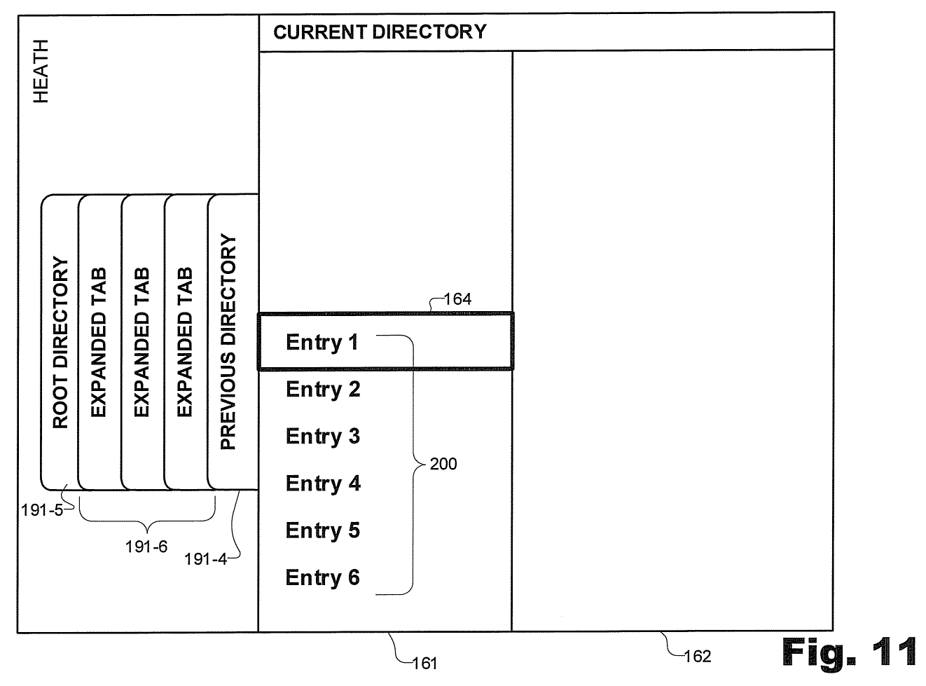

For example, the expandable search history tab 191-3 shown in FIG. 10 indicates that three search tabs are currently hidden from view. A user may select the expandable history tab 191-3 to view the hidden search tabs. FIG. 11 shows the program guide GUI 160 of FIG. 10 after the expandable history tab 191-3 has been expanded. As shown in FIG. 11, the expandable history tab 191-3 has been expanded into three history tabs 191-6. The user may then select one of the expanded history tabs 191-6 as desired. It will be recognized that the number of history tabs 191 that are displayed before an expandable history tab 191-3 is displayed may vary as may serve a particular application.

An exemplary application wherein the main menu GUI 160 may be used to search for one or more media content instances available via the processing subsystem 110 will now be described. Exemplary search applications are described in further detail in co-pending U.S. patent application Ser. No. 11/542,402, entitled “INTERACTIVE SEARCH GRAPHICAL USER INTERFACE SYSTEMS AND METHODS,” filed Oct. 3, 2006 and incorporated herein by reference in its entirety.

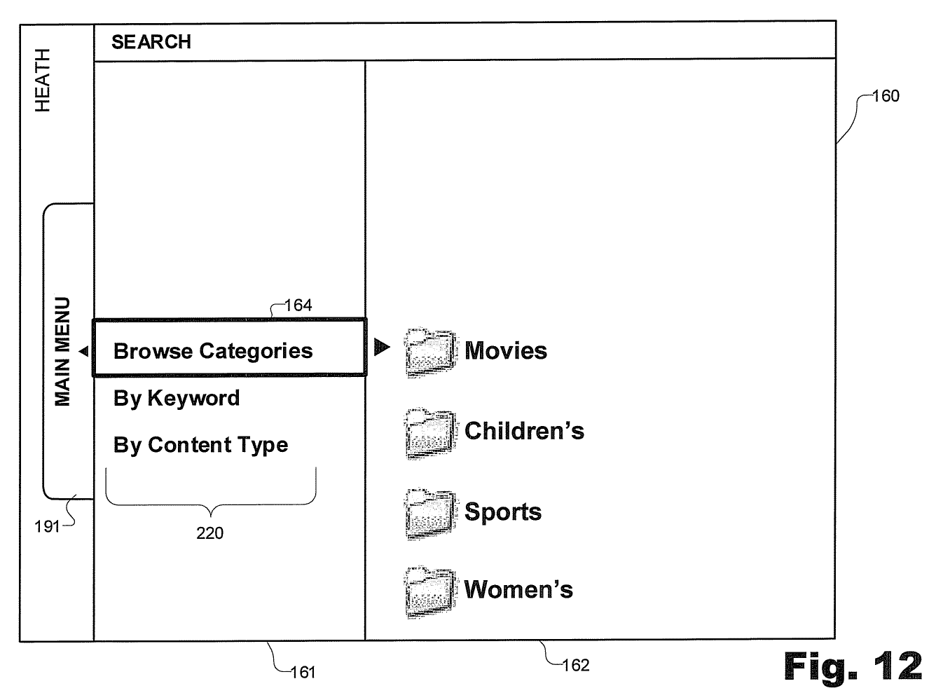

To search for one or more media content instances, a user may select the “Search” entry shown in FIGS. 6-7. FIG. 12 shows the main menu GUI 160 after the “Search” entry has been selected. As shown in FIG. 12, a list 220 of various search options may be displayed in the first viewing pane 161. A user may search by category, keyword, content type, and/or any other criteria as may serve a particular example.

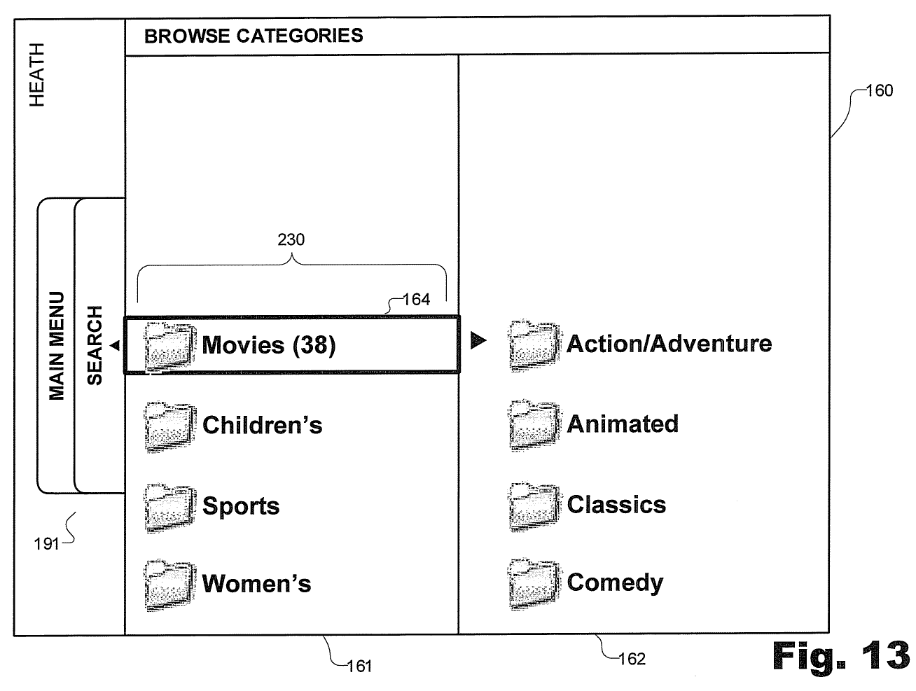

To search by category, for example, the user may simply press the right arrow button 149 when the “Browse Categories” entry is within the magnified area 164. FIG. 13 shows the main menu GUI 160 after the “Browse Categories” entry has been selected. As shown in FIG. 13, a list of categories 230 is displayed within the first viewing pane 161. The list of categories 230 may include any suitable category such as, but not limited to, movies, children's content, sports content, and women's content.

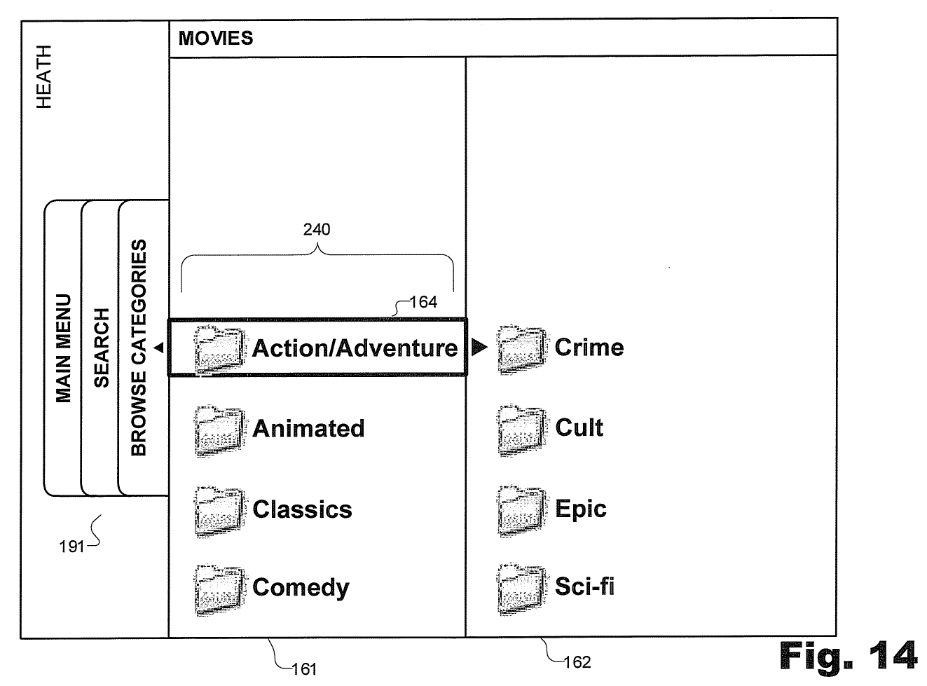

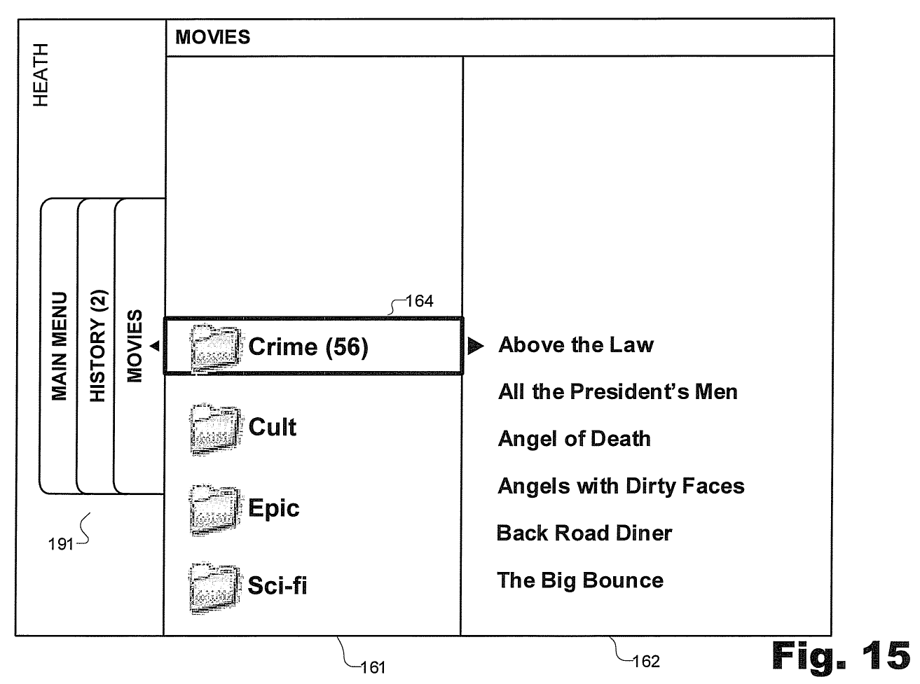

The user may select one of the categories within the list of categories 230 to continue searching for media content contained therein. For example, to search within the “movies” category, the user may simply press the right arrow button 149 while the “movies” entry is within the magnified area 164. FIG. 14 shows the main menu GUI 160 after the “movies” entry has been selected. As shown in FIG. 14, a list of categories 240 related to the “movies” entry is displayed within the first viewing pane 161. The user may continue to search through various sub-directories of movies in a manner similar to that described previously until a desired media content instance is located. For example, FIG. 15 shows the main menu GUI 160 after an “Action/Adventure” entry has been selected from the list of categories 240.

In some examples, if a user desires to return to one of the directories within the search path illustrated in FIGS. 12-15, the user may simply select one of the history tabs 191 shown in FIG. 15.

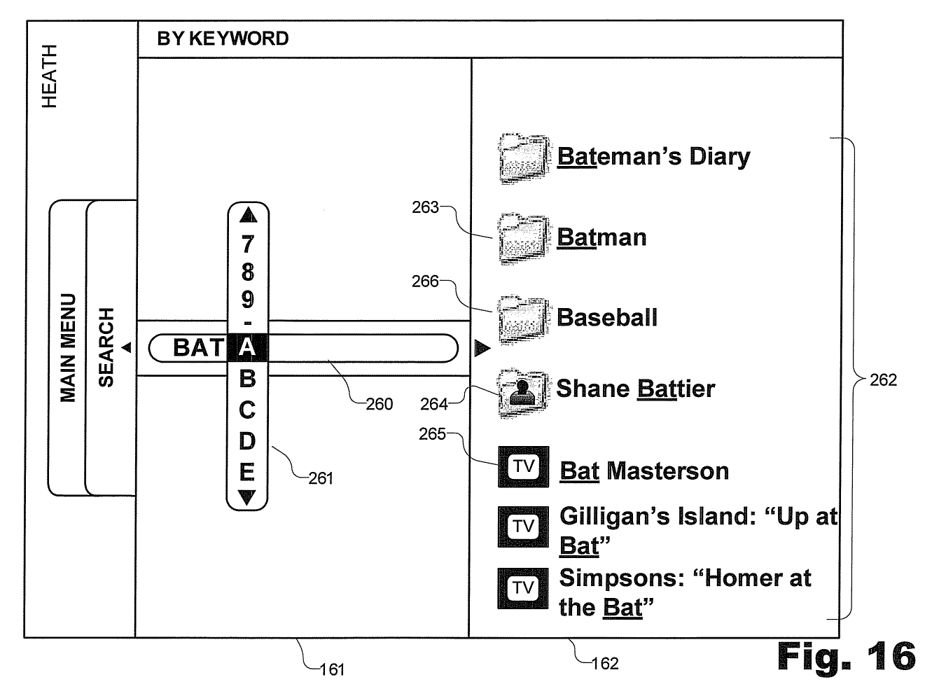

Returning to FIG. 12, a user may alternatively select an option to search by keyword. FIG. 16 shows the main menu GUI 160 after a user has selected the “By Keyword” entry within the options list 220 of FIG. 12. As shown in FIG. 16, the first viewing pane 161 may include a character entry field 260 into which a user may input one or more search terms.

A number of different character (e.g., alpha-numeric) entry methods may be used to input characters into the character entry field 260. For example, as shown in FIG. 16, a “scrolling character wheel” 261 may be provided. The scrolling character wheel 261 shown in FIG. 16 is vertically aligned for illustrative purposes only. In some alternative embodiments, the scrolling character wheel 261 may be horizontally aligned.

To input characters using the scrolling character wheel 261, a user may, for example, use the up and down arrow buttons 151 and 152 to highlight a desired character. For example, as shown in FIG. 16, the character “A” is highlighted. When the desired character is highlighted, the user may press the select button 152 to enter the selected character into the character entry field 260. This process may be repeated to enter subsequent characters into the character entry field 260.

FIG. 16 shows the main menu GUI 160 after the user has entered a number of characters into the character entry field 260. As shown in FIG. 16, a search results list 262 is displayed within the second viewing pane 162. As will be described in more detail below, the search results list 262 is dynamically updated as the user inputs characters into the character entry field 260.

As shown in FIG. 16, the characters “BAT” have been entered into the character entry field 260. Hence, each of the entries within the search results list 262 includes the character sequence “BAT”. However, it will be recognized that one or more of the entries within the search results list 262 may not include the character sequence “BAT” within its respective title, as will be described in more detail below.

In some examples the search results list 262 is dynamically updated in real-time as a user enters each character into the character entry field 260. For example, the search results list 262 may initially include entries containing the character “B” after the user has entered “B” into the character entry field 260. When the user enters the next character “A” into the character entry field 260, the list is dynamically updated or narrowed to include entries containing the character sequence “BA”. This process is repeated until the search results list 262 is narrowed to a satisfactory length.

The entries within the search results list 262 may be of varying type. For example, the search results list 262 may include one or more directories or folders that include a number of related media content instances and/or information associated with one or more media content instances (e.g., the folder labeled “Batman” 263), one or more names of actors or other persons associated with one or more media content instances (e.g., the category labeled “Shane Battier” 264), and/or one or more titles of a specific media content instances (e.g., the television program “Bat Masterson” 265). It will be recognized that the search results list 262 may include any other type of entry as may serve a particular application.

As mentioned, one or more of the entries within the search results list 262 may not include the character sequence (e.g., “BAT”) that has been entered into the character entry field 260 within its respective title. For example, the folder labeled “Baseball” 266 does not include the character sequence “BAT” within its title. However, the baseball folder 266 may include one or more media content instances that have “BAT” within their titles and/or may have a keyword, tag, or other identifier with the character sequence “BAT” contained therein.

Once the search results list 262 has been narrowed to a satisfactory length, the user may press the right arrow button 149 to browse through the search results list 262. In some examples, once the user presses the right arrow button 149, the search results list 262 is transferred from the second viewing pane 162 to the first viewing pane 161. The user may then scroll through the entries within the search results list 262 and preview content related to one or more entries contained therein within the second viewing pane 162.

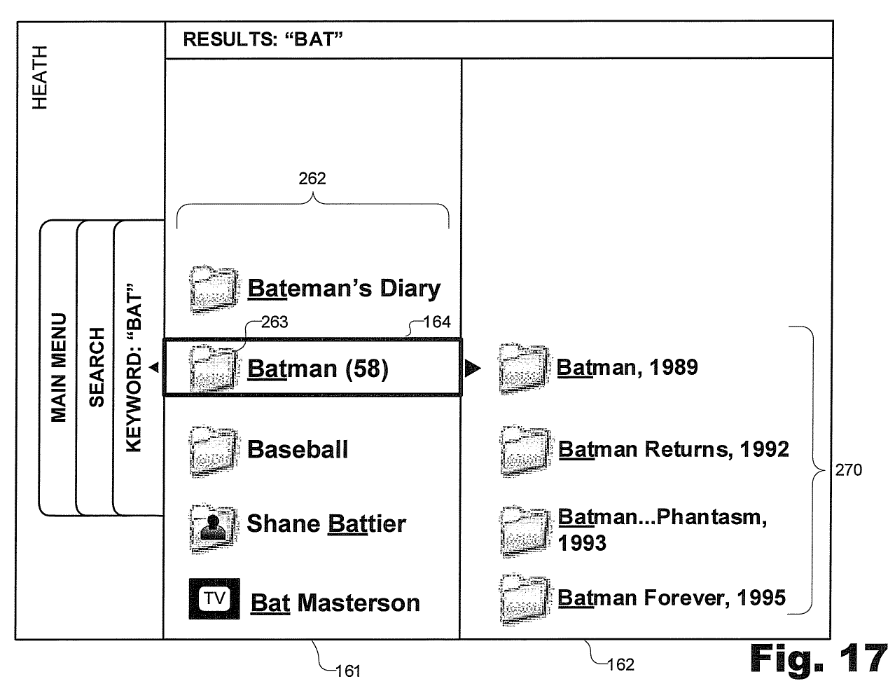

For example, FIG. 17 shows the main menu GUI 160 after the “Batman” folder 263 has been moved into the magnified area 164. As shown in FIG. 17, a list 270 of the content contained within the “Batman” folder 263 is displayed in the second viewing plane 162. The user may continue to search through various sub-directories of the “Batman” folder in a manner similar to that described previously until a desired media content instance is located.

In some examples, the processing subsystem 110 may be configured to automatically pause a currently playing media content instance when the main menu GUI 160 is evoked by a user. If the media content instance is a live television program, for example, the processing subsystem 110 may be further configured to record the media content instance while the main menu GUI 160 is being displayed. In this manner, the user may resume viewing or otherwise experiencing the media content instance after exiting the main menu GUI 160. In some examples, a progress bar or other type of graphic may displayed within the main menu GUI 160 to indicate to the user how much of the current media content instance has elapsed, how much of the current media content instance has been recorded, and/or how much of the current media content instance remains to be viewed.

### III. Exemplary Process View

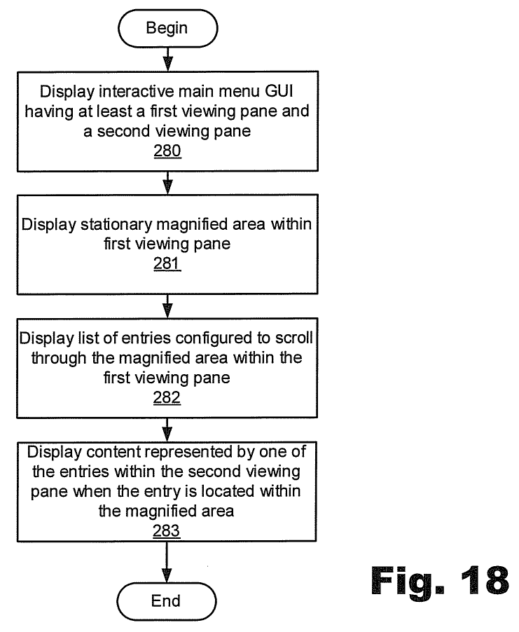

FIG. 18 illustrates an exemplary method of providing a capability of searching and/or browsing through content that may be available via the processing subsystem 110. The steps shown in FIG. 18 are merely illustrative and may be omitted, added to, reordered, and/or modified in any way.

In step 280, a main menu GUI 160 having at least a first viewing pane 161 and a second viewing pane 162 is displayed on the viewing screen 155 of a display device 112. The main menu GUI 160 may be generated using any suitable application within the processing subsystem 110 as described previously.

A stationary magnified area 164 may then be displayed within the first viewing pane 161, as shown in step 281. A list of entries configured to scroll through the magnified area 164 is also displayed within the first viewing pane 161, as shown in step 282. The magnified area 164 is configured to contain one entry at a time as the list of entries is scrolled therethrough. The magnified area 164 is also configured to graphically distinguish a particular entry that is located therein from a remainder of the entries within the list.

Content corresponding to or represented by an entry located within the magnified area 164 may then be displayed within the second viewing pane 162, as shown in step 283. When a new entry is scrolled into the magnified area 164, the second viewing pane 162 is updated to display content associated within the new entry.

### IV. Alternative Embodiments

The preceding description has been presented only to illustrate and describe embodiments of the invention. It is not intended to be exhaustive or to limit the invention to any precise form disclosed. The invention may be practiced otherwise than is specifically explained and illustrated without departing from its spirit or scope. It is intended that the scope of the invention be defined by the following claims.

What is claimed is:

1. A system comprising:
a media content processing subsystem configured to
display an interactive main menu graphical user interface having at least a first viewing pane and a second viewing pane;
display a stationary magnified area within said first viewing pane; and
display a first list of entries within said first viewing pane, each entry of said first list of entries representing content available via said media content processing subsystem;
wherein one entry of said first list of entries is configured to be selectively located within said magnified area; and
wherein, when said one entry is located within said magnified area, said media content processing subsystem is further configured to display content represented by said one entry within said second viewing pane.

2. The system of claim 1, wherein, when said one entry is located within said magnified area, said media content processing subsystem is further configured to graphically distinguish said one entry from a remainder of said first list of entries within said displayed list.

3. The system of claim 1, wherein said content represented by said one entry comprises a second list of entries, and wherein, when said one entry is selected, said media content processing subsystem is configured to transfer said display of said second list of entries to said first viewing pane and display additional content within said second viewing pane, said additional content being related to one of said second list of entries that is located within said magnified area.

4. The system of claim 1, wherein said media content processing subsystem is further configured to display a field indicating a name of a hierarchical representation that includes said first list of entries.

5. The system of claim 1, wherein said media content processing subsystem is further configured to display at least one field indicating a total number of at least a subset of said first list of entries that are not displayed within said first viewing pane.

6. The system of claim 5, wherein said at least one field comprises a header field configured to be displayed above said first list of entries and a footer field configured to be displayed below said first list of entries.

7. The system of claim 1, wherein said media content processing subsystem is further configured to display one or more selectable history tabs configured to graphically represent a number of corresponding hierarchical representations within a browsing thread created by a user during a browsing session.

8. The system of claim 7, wherein said one or more history tabs comprise an expandable history tab configured to expand into a number of additional history tabs when selected.

9. The system of claim 1, further comprising:
a user input device communicatively coupled to said media content processing subsystem and configured to control said media content processing subsystem;
wherein said user input device comprises at least one navigational button; and
wherein said at least one navigational button is configured to
cause said first list of entries to be selectively located within said magnified area; and
select an entry within said first list of entries when said entry is located within said magnified area.

10. The system of claim 1, wherein said content represented by each of said entries comprises at least one of a hierarchical representation of content available via said media content processing subsystem, an option available via said media content processing subsystem, a feature available via said media content processing subsystem, and a media content instance available via said media content processing subsystem.

11. An apparatus comprising:
a graphics engine configured to generate one or more graphics that are displayed by a display device; and
a processor communicatively coupled to said graphics engine, said processor configured to cause said graphics engine to
generate an interactive main menu graphical user interface that is displayed by said display device, said main menu graphical user interface having at least a first viewing pane and a second viewing pane;
generate a stationary magnified area within said first viewing pane; and
generate a first list of entries that is displayed within said first viewing pane, each of said first list of entries representing content available via said processor;
wherein said first list of entries is configured to be selectively located within said magnified area; and
wherein, when one of said first list of entries is located within said magnified area, said processor is further configured to cause said graphics engine to generate and display content represented by said one of said first list of entries within said second viewing pane.

12. The apparatus of claim 11, wherein, when said one of said first list of entries is located within said magnified area, said processor is further configured to cause said graphics engine to graphically distinguish said one of said first list of entries from a remainder of said first list of entries.

13. The apparatus of claim 11, wherein said content represented by said one of said first list of entries comprises a second list of entries, and wherein, when said one of said first list of entries is selected, said processor is configured to cause said graphics engine to transfer said display of said second list of entries to said first viewing pane and display additional content within said second viewing pane, said additional content being related to one of said second list of entries that is located within said magnified area.

14. The apparatus of claim 11, wherein said processor is further configured to cause said graphics engine to generate and display a field indicating a name of a hierarchical representation that includes said first list of entries.

15. The apparatus of claim 11, wherein said processor is further configured to cause said graphics engine to generate and display at least one field indicating a total number of a subset of said first list of entries that are not displayed within said first viewing pane.

16. The apparatus of claim 11, wherein said processor is further configured to cause said graphics engine to generate and display one or more selectable history tabs configured to graphically represent a number of corresponding hierarchical representations within a browsing thread created by a user during a browsing session.

17. The apparatus of claim 16, wherein said history tabs are vertically aligned.

18. The apparatus of claim 16, wherein said one or more history tabs comprise an expandable history tab configured to expand into a number of additional history tabs when selected.

19. The apparatus of claim 11, wherein said content represented by each of said entries comprises at least one of a hierarchical representation of content available via said processor, an option available via said processor, a feature available via said processor, and a media content instance available via said processor.

20. A method comprising:
displaying an interactive main menu graphical user interface having at least a first viewing pane and a second viewing pane;
displaying a stationary magnified area within said first viewing pane;
displaying a list of entries and selectively permitting the moving of at least a subset of said entries through said magnified area within said first viewing pane, each of said list of entries representing content available via a media content processing subsystem; and
displaying content represented by said one of said list of entries within said second viewing pane upon the locating of one of said list of entries within said magnified area.

21. The method of claim 20, further comprising graphically distinguishing said one of said list of entries from a remainder of said list of entries within said displayed list upon the locating of one of said list of entries within said magnified area.

22. The method of claim 20, further comprising displaying a field indicating a name of a hierarchical representation that includes said list of entries.

23. The method of claim 20, further comprising:
creating a browsing thread during a browsing session; and
using said creating for displaying one or more selectable history tabs and graphically representing a number of corresponding directories within said browsing thread.
